(19) United States
(12) Patent Application Publication
(10) Pub. No.: US 2007/0272513 A1
(43) Pub. Date: Nov. 29, 2007

(54) METHOD AND CONTROL UNIT FOR MOVING A GRASPING DEVICE TOWARD A MOVING ARTICLE

(76) Inventors: Karl Josef Gross, Erbach (DE); Gerhard Duerr, Hoecht (DE); Ralf Schaller, Reichelsheim (DE)

Correspondence Address: MICHAEL J. STRIKER, 103 EAST NECK ROAD, HUNTINGTON, NY, 11743, US

(21) Appl. No.: 11/747,030

(22) Filed: May 10, 2007

Related U.S. Application Data
(63) Continuation-in-part of application No. 10/755,140, filed on Jan. 9, 2004, now abandoned.

(30) Foreign Application Priority Data
Jan. 10, 2003 (DE) DE 102 00 606.0

(51) Int. Cl. B65G 47/00; G06F 19/00

(52) U.S. Cl. 198/345.1

(57) ABSTRACT

In a method for approaching a moving article over an approach path, an approach position of the article is situated within an approach region, control data sets are calculated in advance in a first calculation step, the control data sets contain a movement set that includes path segments, which describe the approach path for an approach position, the first calculation step for the movement set is based on a first determined approach position of the article, the movement set for the first determined position of the article is optimized with regard to the approach speed, the current approach position of the article is determined immediately before the start of the movement, a second calculation step is carried out in which the respective path segment to be currently executed is changed as a function of the determined current approach position of the article so that the approach path is shifted in the direction of the current approach position, and an approach movement is carried out by executing the path segment determined in the second calculation step.

### CROSS-REFERENCE TO A RELATED APPLICATION

The invention described and claimed hereinbelow is also described in German Patent Application DE 102 00 606.0 filed on Jan. 10, 2003, it is also a continuation-in-part application of patent application Ser. No. 10/755,140 filed on Jan. 9, 2004. The German Patent Application, whose subject matter is incorporated here by reference, provides the basis for a claim of priority of invention under 35 U.S.C. 119(a)-(d).

### BACKGROUND OF THE INVENTION

The invention relates to a method for approaching a moving article via an approach path and a control unit for controlling the movement of a grasping device.

A procedure that occurs frequently during the manufacturing process is the grasping of an article moving on a conveyor belt with the aid of a grasping device such as a robotic arm or the like. Such a grasping device is controlled by means of a control unit that uses a point-to-point (PTP) interpolation to optimize the approach path with regard to time, i.e. designs the approach path for the fastest possible approach to the article. The calculation of a control data set that predetermines the movement of the grasping device is carried out in real time, i.e. immediately before the start of the approach movement or during the approach movement. If a control data set is executed, i.e. the robotic arm has reached the article toward which it is heading, then the next control data set can be calculated in real time, which can, for example, also include other information such as the output of signals for monitoring, the control of the pick-up or release procedure of the article, and the like. The calculation of these procedures takes up computer time and can interrupt the pick-up procedures of the grasping device so that its movement becomes jerky.

Since the articles are as a rule arranged chaotically on the conveyor belt, before the articles are approached, the duration of the approach movement and the location of the approach position of the article to be approached either cannot be determined or can only be determined with a considerable expenditure of time. For this reason, it is not possible to optimally carry out a precalculation of such an approach movement, as a result of which it is not possible to approach the article in a speed-optimized and movement-optimized, belt-synchronous fashion.

### SUMMARY OF THE INVENTION

The object of the present invention is to approach an article, which is moving on a conveyor belt, in a time-optimized fashion.

This object is attained by the method according to the present invention and the control unit according to the present invention.

According to a first aspect of the present invention, a method is provided for approaching a moving article by means of an approach path. The article has an approach position that is situated within an approach region. In a first calculation step, control data sets are calculated in advance. The control data sets are used for the overall control of the approach movements, i.e. of a robotic arm, and all other functions that are required for monitoring the operating functions or the like. For the approach movement, the control data sets have a movement set that describes the approach path to an approach position. In the first calculation step, the calculation of the movement set starts from a determined approach position of the article.

The movement set for the determined ascent position of the article is thus optimized with regard to the approach speed. Immediately before the start of the approach movement according to the movement set, the current approach position of the article is determined and a second calculation step is carried out in which the current movement set is changed as a function of the determined current approach position so that the approach path is changed in the direction toward the current approach position. The approach movement is then carried out by executing the movement set that has been determined in the second calculation step.

With the method according to the invention, control data sets are thus calculated in advance so that they are available during execution, thus permitting savings of computing time immediately before execution of the respective procedure. In the precalculation of movement sets that predetermine an approach movement toward an article, however, it is not possible to predetermine the position in which the article will be situated at the end of the precalculated approach movement. As a result, the precalculation of movement sets for approach movements is not optimal.

For this reason, before the execution of an approach movement according to the movement set, a recalculation of the movement set is carried out in accordance with the current determined approach position of the article. The article can then be approached with the aid of the recalculated movement set. Since the control data sets for procedures that occur according to this movement set have already been calculated ahead of time, after the relevant approach position for the article has been reached, the next control data set can be immediately executed without requiring a calculation or a determination of the respective subsequent control data set. This permits time savings so that the control data sets such as the movement sets and/or data sets relating to the pick-up and release procedures of the article can be executed essentially one right after another.

Preferably, the control data sets contain the first movement set for the first approach position and a second movement set for a second approach position, which are calculated ahead of time by means of the first calculation step; the first and second movement sets include path segments that describe an approach path to the first or second approach position. Before an end position of the first movement set is reached, at least one first path segment of the second movement set is taken into account in order to assure a smooth transition of the approach movement from the first movement set to the second movement set. In this way, it is possible to execute a so-called “smoothing-over” of the driven movements in which during the driven movement to the first approach position, the second movement set is already taken into account as a result of which the grasping device is subjected to the least powerful possible accelerations so that the approach movements occur in the smoothest, most speed-optimized fashion possible.

This so-called smoothing-over can also be carried out with movement sets that have been computed by means of the first calculating step. The deviation that arises from the less precise calculation of the position of the article can be ignored in the calculation of the smoothing-over so that the precalculation of movement sets furnished by the method according to the invention on the one hand makes the movement of the grasping device gentler in that powerful accelerations are avoided and on the other hand, makes them quicker since control data sets have been calculated in advance so that the control data sets can be executed one after another in immediate succession.

In the second calculation step, the respective current path segment to be executed is preferably changed as a function of the determined current approach position of the article in that the end point of the path segment is shifted by an angle that depends on the current approach position of the article. In this way, the path segments of the movement set that are determined in the first calculation step can essentially be used for an additional calculation; the path segments of the movement set are only corrected by a path that depends on the current approach position of the article. It is thus possible for the calculation of the movement set in the second calculation step to be significantly shortened in comparison to the initial calculation of the movement set so that as little time as possible is required for the calculation of the movement set in the second calculation step.

In one possible embodiment, the respective path segment to be currently executed can be changed in the second calculation step in that the speed of the path segment is taken into account over the entire movement set, thus permitting a smooth start-up and braking of the approach movement. This has the advantage that when calculating the movement set for the current approach position, the movement of the article to be picked up can be taken into account so that at the time of the pick-up, the grasping device is moved along with the article to be picked up.

In order to permit the smoothest possible approach movement, it is possible for the speed of the article to be taken into account in a sinusoidal/quadratic fashion over the entire movement set so that in a starting region and in an ending region, a lower speed of the article is taken into account in the second calculation step.

Preferably, in several movement sets, which have been precalculated by means of the first calculation step, the movement set for a moving article is not converted into an approach movement if it turns out in the second calculation step that the approach movement will not reach the respective moving article on time within the approach region. This prevents the starting of an approach movement if, even before the starting of the approach movement, it is determined that the moving article can no longer be reached within the approach region. This makes it possible to save time that would necessarily have been wasted on a fruitless attempt to pick up the article. In order to define the approach region, a second position of the relevant article can be defined in which the movement set is not calculated in the second calculation step if the relevant article is situated after the second position in the movement direction.

According to another aspect of the present invention, a control unit is provided for controlling an approach movement of an approach device for moving articles. The approach position, i.e. the target position of the approach movement, can be approached within an approach region in accordance with a movement set. The control unit has a first calculation means for precalculating control data sets in a first calculation step. The control data sets include at least one movement set, which is calculated in advance based on a first determined approach position of the article. The movement set describes the approach path; the calculated movement set for the determined approach position of the article is optimized with regard to the approach speed.

The control unit also has a detector system for determining the current position of the article in the approach region. In a second calculation means, immediately before the start of the approach movement, an additional calculation for the movement set is carried out in a second calculation step in which the current movement set is changed as a function of the current position of the article so that the approach path is corrected in the direction toward the approach position. A control element controls the approach movement through execution of the movement set that has been corrected in the second calculation step.

It is thus possible to produce a control unit with which it is possible to carry out the method according to the invention. Movement sets and control data sets can be calculated with the aid of the first and second calculation means. The precalculation of the control data sets makes it possible to reduce the time required to execute a procedure since less time is spent on a calculation immediately before the corresponding procedure of the respective control data set or movement set.

Preferably, the first and/or second calculation means is/are embodied so that at the transition from the first movement set to a second movement set, path segments of the first movement set are offset with path segments of the second movement set so that an essentially smooth transition is achieved from the movement of the first movement set to the movement of the second movement set. This procedure of so-called smoothing-over makes it possible on the one hand to achieve a smooth movement of the processing device and on the other hand, reduces the time required to travel to approach positions.

A preferred embodiment of the invention will be explained in detail below in conjunction with the accompanying drawings.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a processing device for grasping articles moving on a conveyor belt;

FIG. 2 shows the approach region of the processing device; and

FIGS. 3a, 3b show flow charts for illustrating the method according to the invention.

### DESCRIPTION OF THE PREFERRED EMBODIMENTS

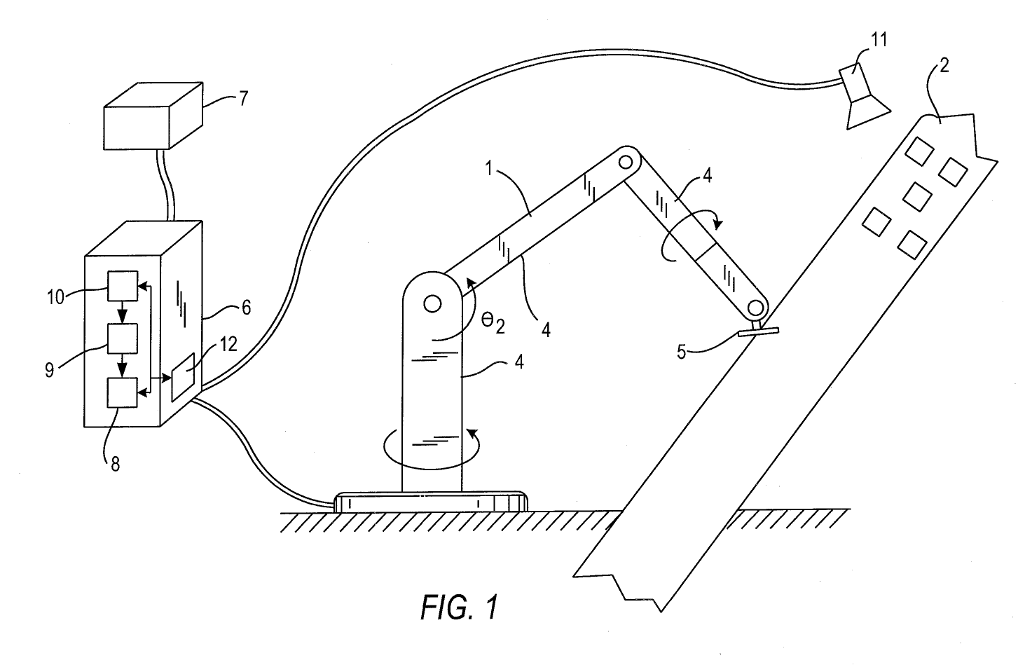

FIG. 1 shows a robotic system for picking up articles 3 that are randomly arranged on a moving conveyor belt 2. The robotic system has a robotic arm 1 equipped with a number of pivoting and/or rotating arm segments 4. The arm segments 4 are connected to one another so that a grasping element 5 at one end of the robotic arm 1 can approach any position within an approach region.

The grasping element 5 is embodied so that it can pick up an article 3 and hold it during a driven movement. To this end, the grasping element 5 can be provided with a grasping claw and/or a magnetic holding system. A different pick-up system is also conceivable, such as a suction apparatus or the like.

The task of the robotic arm 1 is to pick up the article 3 from the moving conveyor belt 2 and transport it, for example, to a paletting position. In the paletting position, the articles 3 are stacked and kept at the ready for another subsequent processing step. A control element 12 in a control unit 6 controls the movement of the robotic arm 1. The control element 12 controls the movements of the robotic arm 1 in accordance with furnished control data so that the robotic arm 1 can approach an approach position predetermined by the control element 12.

The approach path is optimized in accordance with a PTP interpolation (point-to-point interpolation) so that the robotic arm 1 travels into the approach position as quickly as possible. In PTP interpolation, the approach path is divided into a number of path segments and these are optimized with regard to the approach speed. In the optimization of the approach speed, the corresponding actuators of the arm segments 4 are triggered with maximum values so that they are moved into the predetermined position as quickly as possible, i.e. with the maximum possible accelerations and speeds. All involved axes start and finish their movement simultaneously. The movement is laid out on the weakest axis.

The control variables that are supplied to the robotic arm 1 in order to move the grasping element 5 from a starting position to an approach position constitute a movement set. Before the execution of a driven movement, the control unit 6 calculates the movement set and supplies the corresponding control variables to the robotic arm 1 at definite times so that the driven movement is carried out.

In order to monitor the function of the robotic system, after a position is approached, the control unit must send signals to a monitoring system 7. To that end, the control unit 6 likewise generates control data sets that can, for example, prepare a signal output according to which one or more monitoring signals are sent to the monitoring unit 7 after the article 3 has been approached.

In order to save time during the approach movements of the robotic arm 1, the control unit has a first calculation means for precalculating control data sets, e.g. movement sets or signal output data, and for storing them in a memory unit 9. In the memory unit 9, movement sets are then stored for the next approach movements of the robotic arm 1; between the movement sets, additional control data sets can be provided in order, for example, to control signal outputs to the monitoring unit 7 and to carry out further calculations.

The control data sets stored in the memory unit 9 are then executed one after another, i.e. an approach movement of the robotic arm 1 is carried out with the aid of a movement set. After the approach position has been reached, a pick-up or release procedure is executed in accordance with another movement set and signal outputs or the like are initiated, possibly in accordance with one or more control data sets, before a subsequent approach movement of the robotic arm 1 is controlled in accordance with the subsequent movement set. This precalculation makes it possible to save computing time between the individual procedures so that the robotic arm 1 is moved essentially without any waiting time.

Due to multiple influences on the robotic arm 1 and since the articles are randomly arranged, determining the duration for executing one of the control data sets, particularly the movement sets, in advance can only be achieved with difficulty. For this reason, precalculating the movement set exactly with regard to a precise approach position is either impossible or can only be achieved with difficulty. For this reason, before the start of the approach movement toward an approach position, a second calculation must be carried out in accordance with the current movement set with the aid of a second calculation means 10, which calculation recalculates the respective movement set with regard to the current position of the article on the conveyor belt 2.

The current position of the article 3 on the conveyor belt 2 is determined with the aid of a position detection system 11 that determines the more precise absolute position of the article 3 on the conveyor belt 2. With the aid of the second calculation means 10, the respective movement set is calculated so that the approach position of the robotic arm 1 corresponds to the position of the article 3 to be approached at the time at which the grasping element 5 is expected to reach the approach position. Then the grasping element 5 of the robotic arm 1 reaches the approach position at precisely the same time that the article 3 to be approached arrives at the approach position.

In order to accelerate the recalculation of the current movement set shortly before the start of the approach movement in accordance with the movement set, it is useful to carry out the calculation of this movement set so that based on the precalculated movement set, the calculation of the movement set can be accelerated in the second calculation step. To that end, the calculation of the movement set in the first calculation step is carried out in relation to a predetermined starting position.

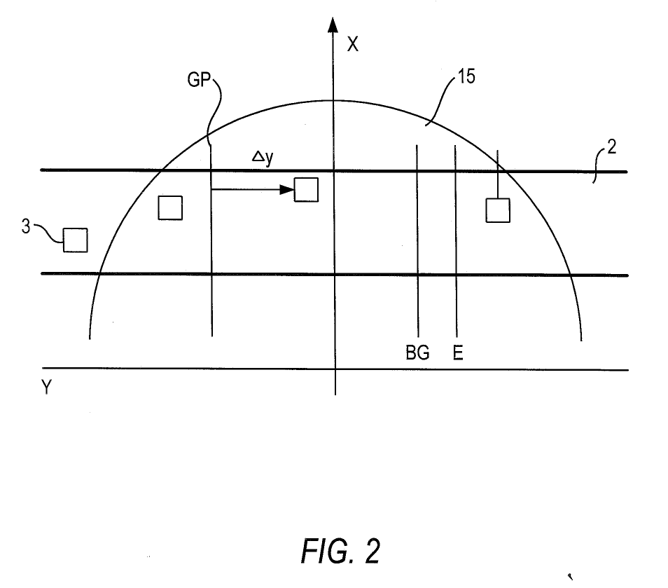

FIG. 2 shows the approach region 15 of the robotic arm 1. The approach region represents the region within which the grasping element 5 can be moved to any random position. The conveyor belt 2 on which the article 3 to be approached is transported travels through the approach region 15. The calculation of the movement set according to the first calculation step is carried out in relation to a starting position GP, i.e. the first calculation step is carried out as though the approach position coincided with the starting position GP.

In the second calculation step, which is carried out immediately before the start of the approach movement toward the relevant article, only the determined position of the article 3 currently to be approached is taken into account with regard to the starting position GP, i.e. the approach position is shifted by a certain amount Δy in the movement direction of the conveyor belt 2 in relation to the starting position GP. In the second calculation step, therefore, based on the movement set that was calculated in the first calculation step and with the aid of the difference Δy, a modified, new movement set is calculated, which is based on an exact approach position so that during execution of the approach movement, the robotic arm 1 and the relevant article 3 both reach the approach position at the same time. In the second calculation step, the end point is shifted by Δy.

The belt speed is added to the path segments of the movement set in a suitable fashion. In order to achieve as smooth as possible an acceleration and braking motion of the robotic arm 1, it is possible for the conveyor speed to be taken into account in a sinusoidal/quadratic fashion in the path segments of the precalculated movement set and for it to be added to the path segments.

Essentially, a movement set is prepared for each article 3 that the detection system 11 has detected and is stored in a calculated favorable sequence in the memory unit 9. At the beginning of the second calculation step, if it is determined that the article is already situated far enough into the approach region 15, i.e. if the difference Δy has become so great that the article probably can no longer be reached with an approach movement, then the movement set is discarded and the process jumps to the next control data set in the sequence stored in the memory unit 9. The decision as to whether to discard the respective movement set is made if the article is situated past a beginning limit position BG, i.e. at the beginning of the second calculation step for the respective movement set of the relevant article 3, if the relevant article is already past the beginning limit position BG, then the second calculation step with the relevant movement set is not carried out.

If the second calculation step yields an estimated approach time after which the article 3 to be grasped would have already passed an end position E, then the second calculation step with regard to this movement set is likewise canceled. This makes it possible to prevent the calculation in the second calculation step of movement sets with which the associated approach movement would no longer reach the relevant article on time within the approach region.

In order to achieve a further speed improvement in the approach movements of the robotic arm 1 and to achieve an increased degree of smoothness, in the second calculation step inside the second calculation means 10, path segments of the current movement set can be offset with part or all of the path segments of the next movement set so that a rounded transition is achieved between the approach movement of the current approach position and the approach movement of the next approach position. This process is referred to as smoothing-over and it reduces accelerations that occur due to an abrupt direction change of the robotic arm 1.

The smooth-over is executed in that during the second calculation step, the path segments close to the approach position are already acted on by the path segments of the subsequent movement set so that in particular, the direction in which the grasping element 5 approaches the article 3 to be grasped is already shifted into the direction in which the next approach position is approached. Furthermore, the smoothing-over can be executed so that the approach movement toward the approach position is not completely adapted to the speed of the article 3, but instead the picking-up or releasing of the article 3 essentially occurs on the fly, thus eliminating a time-consuming braking and re-acceleration of the robotic arm 1. As a result, additional time can be saved when executing the movement sets.

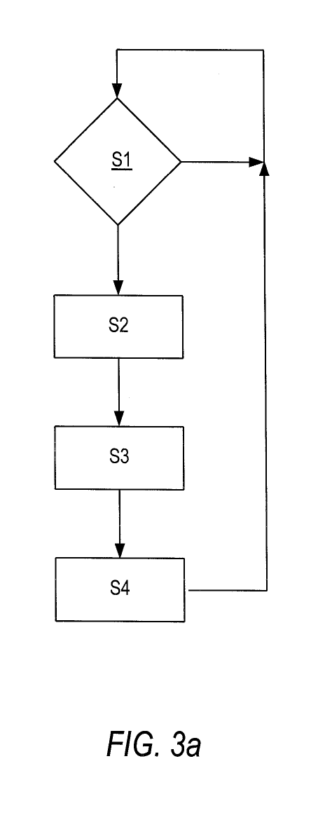

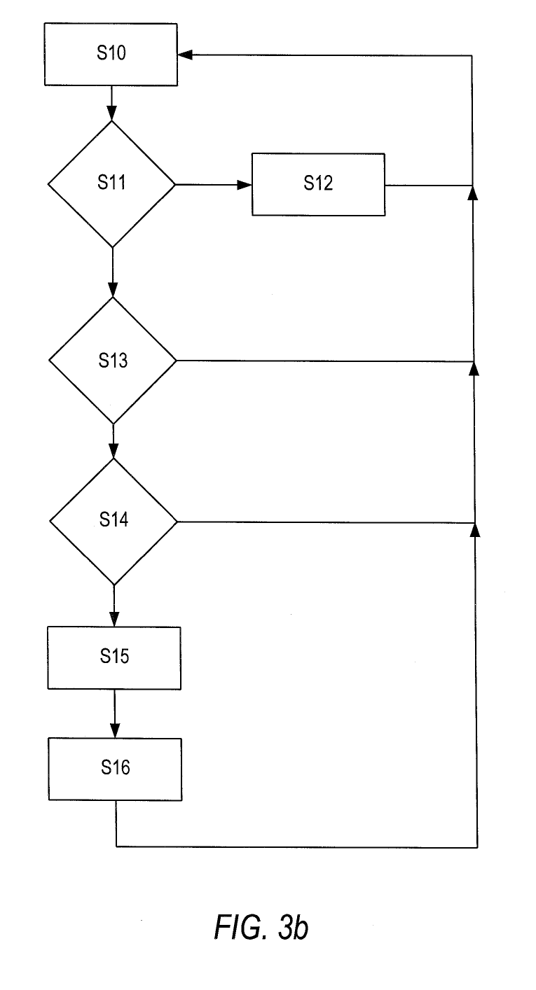

FIGS. 3a, 3b show flow charts for illustrating the method according to the invention in accordance with a preferred embodiment. The method relates to two planes. On the one hand, as shown in FIG. 3a, a check is performed as to whether an article on the conveyor belt has moved into the detection region of the detector system 11. This check is performed in a step S1.

If it has been determined that an article has been moved into the detection region, then its position is determined in a step S2. In the course of this, both the x and the y position are determined. The x position relates to the position of the article in the direction transverse to the movement direction of the conveyor belt 2. The y direction corresponds to the movement direction of the conveyor belt 2. It is also optionally possible for the alignment of the article 3 in relation to the conveyor belt 2 to be determined and furnished in the form of data. The position of the article 3 on the conveyor belt 2 is determined exactly based on these coordinates.

In the following, the relevant detected article 3 is assigned an identification number and in this connection, one or more associated movement sets is/are calculated; a starting position GP is adopted as the y position of the relevant article 3. If necessary, additional control data sets are also determined in the first calculation step S3, which sets can, for example, be provided for transmitting data to the monitoring unit 7. Likewise, it is possible to define movement sets related to the picking-up and releasing of the relevant article 3 by the grasping element 5.

After the control data sets have been determined, they are stored in the memory unit 9. The memory unit 9 is a FIFO memory so that the newly generated control data sets are added to the already existing control data sets. The storage of the data is executed in a step S4. The determination of the control data sets is carried out for each detected article 3 on the conveyor belt 2 as soon as the article 3 has been detected.

FIG. 3b shows an additional process sequence for carrying out the method according to the invention, which is carried out essentially simultaneous to the precalculation process depicted in FIG. 3a. The control data sets stored in the memory unit 9 are now executed one after another. In a step S10, the respective next control data set is read out and in a step S11, a determination is made as to whether the current set is a movement set or some other type of data set.

If the current set is another type of data set, then this is essentially executed in a step S12. The other data set usually relates to the output of signals to the monitoring unit 7 and usually requires no additional calculation. After the other data set has been processed, the process jumps back to step S10.

If the current set is a movement set, then a check is performed in a step S13 as to whether the article in the approach region 15 is still situated before the starting limit position BG. If it has already passed the starting limit position BG in the movement direction, then the calculation of this movement set is cancelled and the process jumps back to step S10 and the processing of the next control data set is initiated.

If the article 3 is still situated before the starting limit position BG, then first, the time for approaching the relevant article 3 is estimated. If it is determined based on the speed of the conveyor belt 2 that the article will be situated after an end position E once this time has elapsed, then the decision is made in step S14 to cancel the calculation process for the second calculation step and to continue with the next control data set according to step S10.

If the calculation in step S14 determines that the relevant article 3 can still be reached, then the precalculated movement set is calculated anew with the aid of the current position of the article. The calculation in the second calculation step can make use of the result of the calculation of the movement set in the first calculation step so that the calculation in the second calculation step requires less time than a recalculation of the entire movement set.

The next movement set stored in the memory unit 9 is taken into account particularly in the second calculation step S15 so that it is possible to calculate a smoothing-over of the approach movement of the current movement set into the approach movement of the next movement set. The fact that respective next movement set is only a precalculated movement set, which was calculated based on a determined starting position, results in only a minimal deviation in the calculation of the smoothing-over. This can generally be ignored since it is automatically compensated for as the sequence of path segments continues. Consequently, the smoothing-over from one approach movement to the next approach movement can essentially be carried out in that for the next approach movement, a movement set is used that is based on the starting position GP as the approach position.

After the movement set has been calculated in the second calculation step, the driven movement is initiated and the movement path is speed-optimized with the aid of PTP interpolation. After execution of the driven movement in step S16, the process jumps back to step S10 and the next control data set is executed.

The idea of the invention is to calculate control data sets in advance so that before each procedure relating to the current control data set, it is not necessary to carry out a calculation that would essentially delay the movement of the robotic arm 1 in movement sets. So that the robotic arm 1 can then control the article 3 exactly, in the control data sets that are movement sets, an additional calculation in a second calculation step is required, which, based on the first calculation step, generates a new movement set in order to approach the relevant article 3 in an exact fashion. This makes it possible to save time since on the one hand, the control data sets that are not movement sets, i.e. are not involved in the movement of the robotic arm 1, are precalculated and therefore, the further calculation in the second calculation step can be accelerated, thus reducing the amount of time during which the robotic arm 1 is at a standstill.

Furthermore, in order to calculate the smoothing-over from one driven movement to the next driven movement of the next robotic arm 1, it is advantageous if the next movement set is already available; in the calculation of the smoothing-over, the movement set that was determined in a first calculation step is essentially sufficient for determining a suitable smoothing-over movement.

In a concrete embodiment, it is naturally possible for the first and second calculation means as well as the control element and/or the memory unit to be provided in one or more microcontrollers; the method according to the invention is either stored as programming code in the microcontroller or is furnished to the microcontroller from elsewhere. The microcontroller can communicate with the monitoring unit 7 via a network (not shown).

The times at which the precalculation of the control data sets takes place are determined in accordance with the capacity utilization of the microcontroller so that the calculation of the movement sets is carried out in the second calculation step, essentially right before the approach movement, while the precalculations are carried out at times during which the microcontroller has available computing capacity.

It will be understood that each of the elements described above, or two or more together, may also find a useful application in other types of methods and constructions differing from the type described above.

While the invention has been illustrated and described as embodied in a method and control unit for moving a grasping device toward a moving article, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for approaching a moving article (3) over an approach path, wherein an approach position of the article is situated within an approach region (15), the method comprising the steps of calculating control data sets in advance in a first calculation step; providing in the control data sets a movement set that describes the approach path to an approach position; basing the first calculation step for the movement set on a determined approach position of the article; optimizing the movement set for a first determined position of the article with regard to an approach speed; determining a current approach position of the article (3) immediately before a start of the approach movement according to the movement set; carrying out a second calculation step in which a respective current movement set is changed as a function of the determined current approach position of the article (3) so that the approach path is changed in a direction of the current approach position; and carrying out an approach movement by executing a movement set determined in the second calculation step.

2. The method as recited in claim 1, further comprising providing in the movement set a piece of information about path segments, which describes the approach path to the approach position, and executing the path segments one after another.

3. The method as recited in claim 2, further comprising providing in the control data sets a first movement set for a first approach position and a second movement set for a second approach position, both of which are calculated in advance by the first calculation step, including in the second movement set path segments that execute an approach path to the second approach position, and before an end position of the first movement set is reached, taking into account at least a first one of the path segments of the second movement set in order to assure a smooth transition of the approach movement from the first movement set to the second movement set.

4. The method as recited in claim 2, further comprising in the second calculation step, changing a respective path segment to be currently executed as a function of the determined current position of the article (3) in that an end point of a path segment of the movement set is shifted by a distance that depends on the current approach position of the article (3).

5. The method as recited in claims 1, further comprising in the second calculation step, changing a respective path segment to be currently executed as a function of a movement speed of the article (3) in that the speed of the article (3) is taken into account over the entire movement set, thus permitting a smooth acceleration and braking of the approach movement.

6. The method as recited in claim 5, further comprising taking into account the speed of the article (3) in a sinusoidal/quadratic fashion over the entire movement set so that in a starting region and an ending region, a lower speed of the article (3) is taken into account in the second calculation step.

7. The method as recited in claims 1, further comprising precalculating several movement sets by the first calculation step and with a plurality of moving articles (3), the movement set(s) associated with a moving article (3) is/are not converting into an approach movement if it turns out in the first calculation step that the approach movement will not reach a respective moving article (3) on time within the approach region.

8. The method as recited in claim 7, further comprising providing that the respective moving article (3) is not reached on time within the approach region (15) if the relevant article (3) is situated past a second position in a movement direction.

9. A control unit (6) for controlling an approach movement of an approach device for moving articles (3), wherein it is possible to approach an approach position within an approach region (15), the control unit (6) comprising a first calculation means (8) for precalculating control data sets in a first calculation step, the control data sets include at least one movement set that is calculated in advance based on a determined approach position of the article (3), the movement set describes the approach path, and a calculated movement set for the determined position of the article (3) is optimized with regard to the approach speed; a detector system (11) for determining a current position of the article (3); a second calculation means (10) for carrying out an additional calculation for the movement set in a second calculation step immediately before a start of the approach movement, in which a current movement set is changed as a function of the determined current position of the article so that the approach path is changed in a direction of the approach position, and a control element (12) for controlling the approach movement through an execution of the movement set that was changed in the second calculation step.

10. The control unit (6) as recited in claim 8, further comprising a memory element for storing a plurality of movement sets in advance.

11. The control unit (6) as recited in claim 9, wherein the first and/or second calculation means (8, 10) is/are embodied so that at a transition from the first movement set to a second movement set, path segments of the first movement set are offset with path segments of the second movement set so that an essentially smooth transition is achieved from a movement of the first movement set to a movement of the second movement set.
